(19) United States
(12) Patent Application Publication
(10) Pub. No.: US 2010/0156715 A1
(43) Pub. Date: Jun. 24, 2010

(54) METHOD AND DISPLAYING ACCOMPANYING VEHICLE POSITION INFORMATION AND APPARATUS THEREOF

(75) Inventors: Kyoung Soon KANG, Daejeon (KR); Ki Cheol JEON, Daejeon (KR); Wang Bong LEE, Daejeon (KR); Boo Geum JUNG, Daejeon (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics and Telecommunications Research Institute, Daejeon (KR)

(21) Appl. No.: 12/545,934

(22) Filed: Aug. 24, 2009

(30) Foreign Application Priority Data
Dec. 19, 2008 (KR) 102008-0130478

(51) Int. Cl. G01S 1/00; G06F 3/048

(52) U.S. Cl. 342/357.09; 715/810; 715/764

(57) ABSTRACT

The present invention relates to a method for displaying accompanying vehicle position information and an apparatus thereof. The method for displaying the position information according to the present invention receives position information, displays the received position information with a unique identifier of a preset partner terminal, when the position information includes the unique identifier, and displays the received position information with an own identifier, when the position information does not include the unique identifier. According to the present invention, it is possible to display the accompanying vehicle position information with the own position information, without using a separate group management server.

### CROSS-REFERENCE TO RELATED APPLICATION

This application claims the benefit of Korean Application No. 10-2008-0130478, filed on Dec. 19, 2008 in the Korean Intellectual Property Office, the disclosure of which is incorporated by reference.

### BACKGROUND OF THE INVENTION

1. Field of the Invention

The present invention relates to a method for displaying position information and an apparatus thereof, and more particularly, to a method for displaying position information and an apparatus thereof which are capable of displaying accompanying vehicle position information without using a separate server.

2. Description of the Related Art

With the growth of a navigation market using a Global Positioning System (GPS), a variety of functions are performed in one system. However, such developments are mostly limitedly made in one terminal. In addition, although multimedia functions, such as Digital Multimedia Broadcasting (DMB), video, audio and graphic image viewer, have been developed, the communication is limited to unilateral reception, such as Transport Protocol Experts Group (TPEG).

In this regard, in the case of accompanying vehicles departing from different departure places to one destination, a user can check an own vehicle traveling state, but should use a phone or another medium to check another vehicle traveling state. Moreover, a conventional method for displaying an accompanying vehicle needs a separate server for controlling a group, or should use a position database server for managing a position database so as to acquire accompanying vehicle position information.

### SUMMARY OF THE INVENTION

Therefore, an object of the present invention is to provide a method for displaying position information and an apparatus thereof which are capable of displaying accompanying vehicle position information without using a separate server.

A method for displaying position information according to the present invention for achieving the above object includes: receiving position information; displaying the position information with a unique identifier of a preset partner terminal, when the position information includes the unique identifier; and displaying the position information with an own identifier, when the position information does not include the unique identifier.

In the meantime, an apparatus for displaying position information according to the present invention includes: a display unit; a communication unit for receiving position information; and a controller for displaying the position information on the display unit with a unique identifier of a preset partner terminal, when the position information includes the unique identifier, and displaying the position information on the display unit with an own identifier, when the position information does not include the unique identifier.

### BRIEF DESCRIPTION OF THE DRAWINGS

The above and other objects, features and advantages of the present invention will become more apparent from the following description of preferred embodiments given in conjunction with the accompanying drawings, in which:

FIG. 1 is a diagram referred to in roughly explaining a method for displaying position information according to the present invention;

FIG. 2 is a block diagram of a first terminal shown in FIG. 1; and

FIG. 3 is a flowchart provided in explaining a method for displaying accompanying vehicle position information according to an exemplary embodiment of the present invention.

### DETAILED DESCRIPTION OF THE INVENTION

Hereinafter, the present invention will be explained in detail with reference to the drawings.

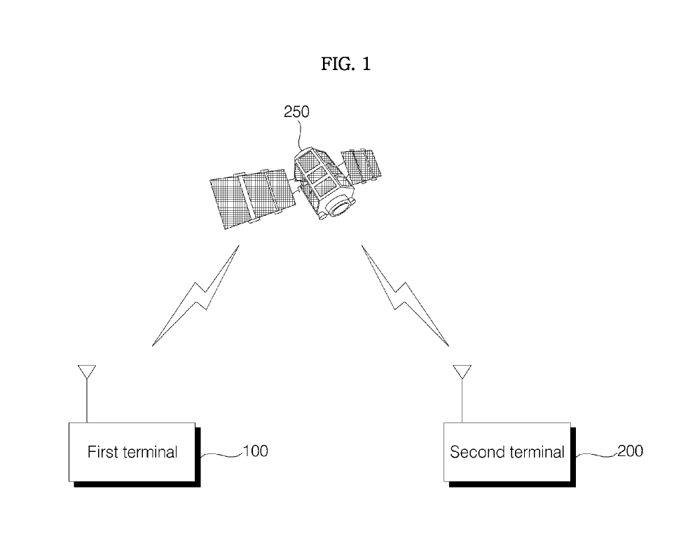

FIG. 1 is a diagram referred to in roughly explaining a method for displaying position information according to an exemplary embodiment of the present invention.

Referring to FIG. 1, a first terminal 100 is installed in a vehicle of a user, and a second terminal 200 is installed in an accompanying vehicle. The first and second terminals 100 and 200 are capable of acquiring position information via a GPS satellite 250.

The first and second terminals 100 and 200 can add their own identifiers to the received position information, and transmit the position information to each other, respectively. Therefore, the first and second terminals 100 and 200 can identify the received position information as own position information or partner position information according to whether or not the position information includes a partner identifier, so that they can distinguishably display the own position information and the partner position information on a screen.

The foregoing process makes it possible to display position information of one or more vehicles, without using a separate group management server for grouping and managing accompanying vehicles.

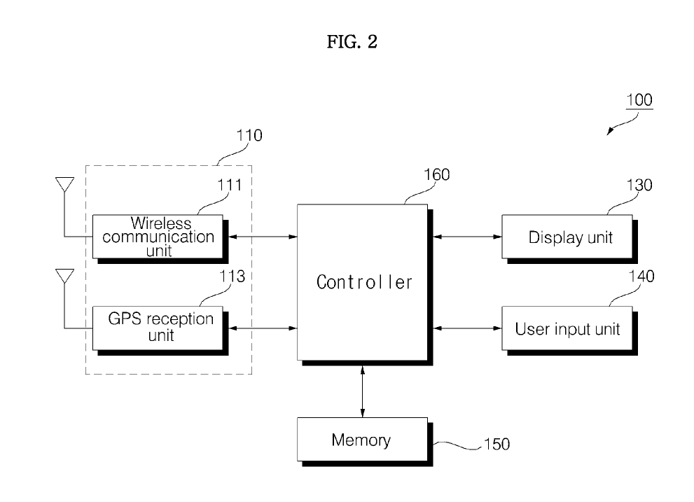

FIG. 2 is a block diagram of the first terminal shown in FIG. 1. The second terminal installed in the accompanying vehicle is basically identical in construction and function to the first terminal.

Referring to FIG. 2, the first terminal 100 includes a communication unit 110, a display unit 130, a user input unit 140, a memory 150 and a controller 160. The communication unit 110 may include a wireless communication unit 111 and a GPS reception unit 113.

In the communication unit 110, the wireless communication unit 111 can provide various communication interfaces, such as Code Division Multiple Access (CDMA), Wireless LAN (WLAN)(Wi-Fi), Wireless broadband (Wibro), World Interoperability for Microwave Access (Wimax), and High Speed Downlink Packet Access (HSDPA), and set using priorities according to a signal intensity or the like. The GPS reception unit 113 provides a function of receiving a GPS satellite signal, performing a certain signal processing process, and checking a current position.

The display unit 130, which is comprised of a Liquid Crystal Display (LCD), displays a menu for operation control, a signal reception state, battery information, and information on an operation state of the broadcasting reception terminal by a command input by a user, and plays back a broadcasting program wanted by the user. The user input unit 140 has a plurality of keys including numeral keys and function keys, and transfers a signal corresponding to a key pressed by the user to the controller 160, to thereby input an operation command or data of the user.

The memory 150, which is comprised of a ROM, RAM or flash memory, stores programs or data required for a terminal operation, and various data which the user wants to store. Especially, the memory 150 stores a unique identifier of another set terminal.

The controller 160 controls the overall operation of the broadcasting reception terminal by controlling the operations of the respective units. Particularly, when the received position information includes a unique identifier of a preset partner terminal, the controller 160 can display the position information on the display unit 130 with the unique identifier, and when the received position information does not include the unique identifier, the controller 160 can display the position information on the display unit 130 with an own identifier.

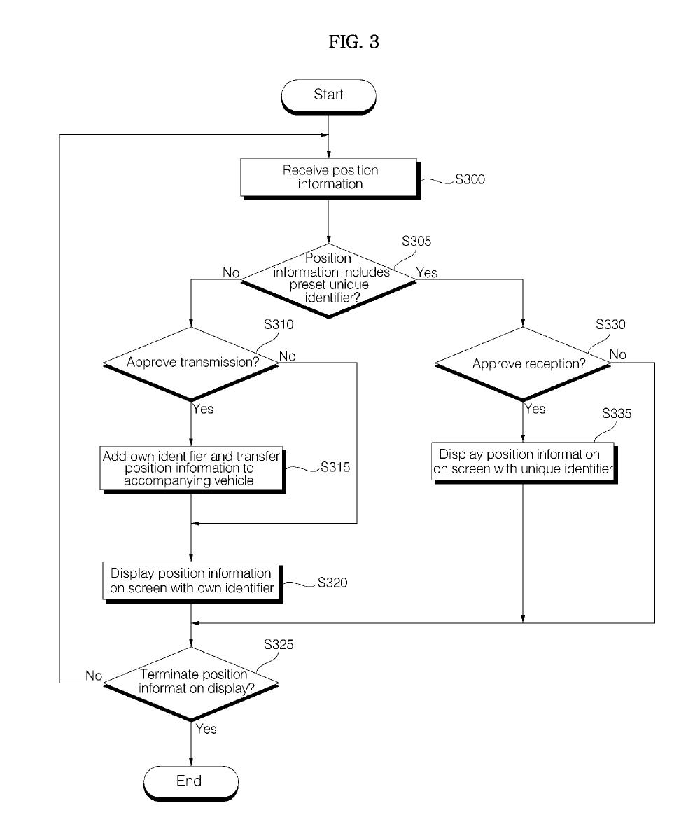

FIG. 3 is a flowchart provided in explaining a control method of a terminal according to an exemplary embodiment of the present invention. Referring to FIG. 3, after a mode for displaying position information is set, when a first terminal 100 receives position information through a communication unit 110 (S300), the controller 160 examines whether or not the received position information includes a preset unique identifier (S305). Here, the unique identifier is granted to an accompanying vehicle in advance and stored in a memory 150. When not including such a unique identifier, the received position information is judged as own position information.

As the judgment result of step S305, when the received position information is the own position information, the controller 160 can create a group with the accompanying vehicle according to a setting state, i.e., whether or not to transmit the own position information to a second terminal 200 positioned in the accompanying vehicle. Whether or not to transmit the own position information to the second terminal 200 may be set in a separate menu.

If set to approve the transmission, the controller 160 adds an own identifier to the own position information, and transfers the own position information to the second terminal 200 through the communication unit 110 (S315). This process can be carried out at intervals of a certain time or by a request of a partner terminal. And, the controller 160 displays the received position information on a display unit 130 with the own identifier (S320). Here, the position information may be displayed with supplementary information on a map screen.

As the examination result of step S305, when the received position information includes the unique identifier, the controller 160 can create a group with the accompanying vehicle according to a setting state, i.e., whether or not to approve the reception (S330). Also in this case, whether or not to approve the reception may be set in a separate menu.

If set to approve the reception, the controller 160 displays the received position information on the display unit 130 with the unique identifier (S335).

The foregoing process is repeated until the termination of the position information display is selected (S325). In addition, when this process is ended, group information including unique identifiers is stored in the memory 150, so that it can be referred to in a future journey or used to check a current position. And, in the method for displaying the position information and the apparatus thereof according to the present invention, the construction and method of the exemplary embodiments described above are not limitedly applied, but the whole or parts of each exemplary embodiment may be selectively combined to make various modifications.

As discussed earlier, according to the present invention, it is possible to display the accompanying vehicle position information with the own position information, without using a separate server for converting and storing position data of the respective vehicles. As a result, since it is possible to confirm the own vehicle position information and the registered accompanying vehicle position information at the same time, a route of the accompanying vehicle can be predicted and a more exact position thereof can be confirmed. In addition, as compared with a method using a separate server, this method simplifies the process of grouping the accompanying vehicles.

While the exemplary embodiments of the present invention have been illustrated in the drawings and described above, the present invention is not limited thereto. It will be apparent to those skilled in the art that various modifications can be made to the described exemplary embodiments without departing from the spirit or scope of the present invention defined by the appended claims.

What is claimed is:

1. A method for displaying position information, comprising:
receiving position information;
displaying the position information with a unique identifier of a preset partner terminal, when the position information includes the unique identifier; and
displaying the position information with an own identifier, when the position information does not include the unique identifier.

2. The method of claim 1, further comprising adding the own identifier to the position information which does not include the unique identifier, and transmitting the position information to the partner terminal.

3. The method of claim 2, further comprising providing a menu for selecting whether or not to transmit the position information including the own identifier.

4. The method of claim 1, further comprising providing a menu for selecting whether or not to display the position information including the unique identifier.

5. The method of claim 1, wherein the position information which does not include the unique identifier is information generated on the basis of a GPS satellite signal.

6. An apparatus for displaying position information, comprising:
a display unit;
a communication unit configured to receive position information; and
a controller configured to display the position information on the display unit with a unique identifier of a preset partner terminal, when the position information includes the unique identifier, and display the position information on the display unit with an own identifier, when the position information does not include the unique identifier.

7. The apparatus of claim 6, wherein the controller adds the own identifier to the position information which does not include the unique identifier, and transmits the position information to the partner terminal.

8. The apparatus of claim 7, wherein the controller displays a menu for selecting whether or not to transmit the position information including the own identifier on the display unit.

9. The apparatus of claim 6, wherein the communication unit comprises:
a GPS reception unit for receiving position information generated on the basis of a GPS satellite signal; and
a wireless communication unit for receiving position information of the partner terminal.

10. The apparatus of claim 6, further comprising a memory for storing the unique identifier of the set partner terminal.
